(19) United States
(12) Patent Application Publication
(10) Pub. No.: US 2024/0156246 A1
(43) Pub. Date: May 16, 2024

(54) LIGHT GUIDE MEMBER AND INDICATOR LIGHT ASSEMBLY

(71) Applicant: KONINKLIJKE PHILIPS N.V., EINDHOVEN (NL)

(72) Inventors: Kevin Arnold MILLER, Bellevue, WA (US); Tianyi WANG, Kenmore, WA (US); Pascal Jean Henri BLOEMEN, Eindhoven (NL); Nathan FARRELL, Kirkland, WA (US); Marinus Arnoldus Martinus VUGTS, Beetsterzwaag (NL)

(21) Appl. No.: 18/281,860

(22) PCT Filed: Mar. 21, 2022
(86) PCT No.: PCT/EP2022/057267

§ 371 Date: Sep. 13, 2023

Related U.S. Application Data
(60) Provisional application No. 63/166,946, filed on Mar. 26, 2021.

(51) Int. Cl. A46B 15/00; A61C 17/22

(52) U.S. Cl. CPC A46B 15/0044; A61C 17/225

(57) ABSTRACT

A light guide member (100, 200, 300, 400) for a power device (10) includes a ring-shaped body (34) adapted to be disposed within a housing (22) of the power device (10). The ring-shaped body (34) has an outer surface (63) that is contoured to complement an inner surface (50) of the housing (22), and includes a light receiving surface (44, 46) and a light emitting surface (48). The ring-shaped body (34) further includes a light coupling portion (42) adapted to accommodate a light source (30, 32) and configured to direct light emitted by the light source (30, 32) to the light receiving surface (44, 46). Light received by the light receiving surface (44, 46) propagates through the ring-shaped body (34) via internal reflection to the light emitting surface (48) where the light is directed out of the light guide member and uniformly illuminates a portion (53) of an outer surface (52) of the housing (22) of the power device (10).

### FIELD OF THE INVENTION

The present disclosure relates generally to a light guide member and indicator light assembly for power devices, such as electric oral care devices, and related methods, wherein light is directed from one or more light sources through a ring-shaped light guide member to an outer surface of the housing of the device.

### BACKGROUND

Power oral care devices, such as electric toothbrushes, oral irrigators, flosser devices or combination devices often use a tube-shaped handle which houses an internal assembly and supports external displays. Indicators on the handle may be useful in announcing a status or action of the device and may also provide information related to a parameter that is being monitored. For example, during a cleaning session, pressure applied to the oral tissues can be monitored by pressure sensors and an indicator can warn a user when excessive force or too little brushing force is applied.

Conventional display systems provided on the handles of power handheld devices are limited in display capacity because their relatively large “user interface real estate” taken up by the display on the handle that may impede facile positioning of the device causing interference of the user's hands with the indicators or display on the handle while the device is being used.

Furthermore, in conventional systems, light sources arranged on a flexible printed circuit substrate which in turn is electrically connected to a rigid printed circuit board such that a desired amount of light can be guided towards a desired location on the handle are typically expensive to manufacture due to the number of different components, materials, and processes required.

Some power devices have hidden interface panels, which are blank when the device is off and visible when the device is on, and include structurally complex components that are composed of many different parts. As a result, hidden panels are expensive and time-consuming to manufacture. Additionally, with compact devices, such as handheld oral care devices, in order to comfortably fit in a user's hand there are space constraints, and conventional light diffusion distances are not possible. Such and other disadvantages and drawbacks associated with the currently available solutions for providing visual feedback in the form of light output of power devices thus persist.

### SUMMARY

There is a need for devices that can direct light emitted by one or more light sources within a housing to an outer surface of the housing so that a desired area of the housing is illuminated with improved visibility during use, sufficient light intensity, and uniform light distribution to provide visual feedback to a user, in an esthetically pleasing, efficient and cost-effective manner and with minimal interference with the existing internal assembly of the device.

According to the implementations and embodiments described herein addressing such a need, a light guide member and indicator light assembly are provided for use in a power device. The indicator light assembly provides an optically efficient light guiding path, can be manufactured at a reduced cost, and can be placed within tight space constraints of the handle of the power device. The different aspects of the embodiments described below provide visual feedback to a user of the power device in the form of an illuminated ring at the proximal end of the power device while the device is being used without requiring a large number of light sources, light guiding components, or a flexible printed circuit substrate, and thereby reduces the cost and/or time of assembly.

In some implementations, a light guide member for a power device may include a ring-shaped body adapted to be disposed within a housing of the power device and having an outer surface contoured to complement an inner surface of the housing. The ring-shaped body further includes a light receiving surface, a light emitting surface, and a light coupling portion adapted to accommodate a light source and configured to direct light emitted by the light source to the light receiving surface. Light received by the light receiving surface can propagate through the ring-shaped body via internal reflection to the light emitting surface where the light is directed out of the light guide member and uniformly illuminates a portion of an outer surface of the housing of the power device.

In some embodiments, the light coupling portion includes a cutout portion, optionally provided with a reflector. In other embodiments, the light receiving surface of the ring-shaped body can be located on a compliant arm of the ring-shaped body or on a compliant part. In further embodiments, the light coupling portion may have an extension arm that curves inward towards a center of the ring-shaped body to facilitate coupling of the light sources to the light receiving surface. In some embodiments, the illuminated portion of the outer surface of the housing includes an outer circumference of the housing. In further embodiments, the light emitting surface can provide uniform illumination at a proximal end of the power device. Optionally, a diffusing element may be coupled to the light emitting surface of the ring-shaped body for diffusing light at the outer surface of the housing.

In other implementations, an indicator light assembly for a power device may include a housing configured to be held in a hand of a user, a light source, a light guide member having a ring-shaped body adapted to be disposed within the housing and having an outer surface that is contoured to complement an inner surface of the housing. The ring-shaped body may further include a light receiving surface, a light emitting surface, and a light coupling portion for housing the light source and adapted to optically couple the light source to the light receiving surface. Light received by the light receiving surface can propagate through the ring-shaped body via internal reflection to the light emitting surface where the light is directed out of the light guide member and uniformly illuminates a portion of an outer surface of the housing. The light source and the light guide member are configured to provide visual feedback to the user about a parameter being monitored during a working session of the power device.

In further possible implementations, a method for illuminating an outer surface portion of a housing of a power device includes providing the housing of the power device with a light source configured to emit light in response to a parameter that is being monitored by the power device during a working session of the power device, and a light guide member. The light guide member may include a ring-shaped body adapted to be disposed within the housing and has an outer surface contoured to complement an inner surface of the housing, a light receiving surface, a light emitting surface, and a light coupling portion adapted to accommodate the light source and configured to direct light emitted by the light source to the light receiving surface. The method further includes causing light to be emitted from the light source onto the light receiving surface, transmitting the emitted light via the ring-shaped body by internal reflection to the light emitting surface to exit the housing, thereby uniformly illuminating a portion of an outer surface of the housing, and providing visual feedback to the user about the parameter monitored during a working session of the power device.

These and other aspects of the disclosure will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the inventive subject matter.

FIG. 1 is a front view of an electric toothbrush incorporating an exemplary embodiment of an indicator light assembly.

FIG. 2 is a close-up detail of the indicator light of the electric toothbrush of FIG. 1.

FIG. 3 is a front perspective view of an embodiment of a light guide member provided with two light sources.

FIG. 4 is a close-up detail of a light coupling portion of the light guide member shown in FIG. 3.

FIG. 5 is a back perspective view of the light guide member shown in FIG. 3.

FIG. 6 is a back view of the light guide member shown in FIG. 3.

FIG. 7 is a longitudinal cross-sectional view of an electric toothbrush including an indicator light assembly.

FIG. 8 is a longitudinal cross-sectional view of the housing and the light guide member of the indicator light assembly shown in FIG. 7.

FIG. 9 is another longitudinal cross-sectional view of the electric toothbrush provided with the indicator light assembly shown in FIG. 7.

FIG. 10 is a schematic representation illustrating the principle of internal reflection as used in a light guide.

FIG. 11 is a front perspective view of another embodiment of a light guide member provided with a reflector.

FIG. 12 is a back perspective view of another embodiment of a light guide member including a slot for compliance at a light coupling portion.

FIG. 13 is a back perspective view of an embodiment of a light guide member including a compliant part.

FIG. 14 is a perspective view of a portion of the light guide member shown in FIG. 13.

FIG. 15 is a transverse cross-sectional view of another embodiment of a light guide member including extension arms.

### DETAILED DESCRIPTION OF EMBODIMENTS

The disclosed subject matter will become better understood through review of the following detailed description in conjunction with the figures. The detailed description and figures provide example embodiments of the invention described herein. Those skilled in the art will understand that the disclosed examples may be varied, modified, and altered without departing from the scope of the invention described herein.

Throughout the following detailed description, various examples of light guide members, indicator light assemblies, and illumination methods are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. It should be readily understood that a given feature need not be the same or similar to the specific portrayal of a related feature or example.

An electric toothbrush will be used to generally describe the various aspects of the disclosed subject matter. The description of such an electric toothbrush is meant to be exemplary and the use of various features and aspects of the inventive subject matter to other power devices is considered to be within the scope of the invention. The illumination features may correspond to particular functions that are being performed and/or convey status information of the device to a user.

Some embodiments described herein can be implemented to provide brushing information and/or feedback to a user of an electric toothbrush, such as a Philips Sonicare DiamondClean Smart™ toothbrush (manufactured by Koninklijke Philips Electronics, N.V.). For electric toothbrushes, brushing behavior and cleaning of teeth can be substantially improved because a user can stay informed regarding the status of the electric toothbrush while using the toothbrush. The conveyed information can, for example, be related to the amount of pressure applied by a user during brushing. Other examples of information that can be conveyed include: indications related to an error occurring, alert messages (for example, indicate when a battery is due to be changed or charged, or indicate when to change a brush head), instructions or indications related to proper use of the power toothbrush, or timer or sensory result messages (for example, indicate that teeth are fully cleaned or partially cleaned teeth, indicate good brushing behavior, poor brushing behavior, or provide information related to plaque formation).

In other embodiments, pertinent information and/or indications can be provided to users of any power device, handheld or non-handheld, including medical, dental, shaving, grooming, mother and child care devices, which can incorporate the configurations and functionalities described herein.

In some embodiments, the indicator light takes the form of a light ring illuminating the periphery at the proximal end of the power device so that the light ring is visible while the user is using the device. The light ring can be formed by emitting light from one or more light sources, such as light emitting diodes (LEDs), which are internally optically coupled to a light receiving portion of a ring-shaped light guide member allowing even dispersion of light and providing a user with good visibility of the light from all sides of the handle.

The term “light source” should be understood to refer to any one or more of a variety of electromagnetic radiation sources, including, but not limited to, light-emitting diode (LED) based sources (including one or more LEDs as defined herein), incandescent sources (e.g., filament lamps, halogen lamps), fluorescent sources, phosphorescent sources, high-intensity discharge sources (e.g., sodium vapor, mercury vapor, and metal halide lamps), lasers, and other types of electroluminescent sources.

The term “LED” (light emitting diode) should be understood to include any electroluminescent diode, or other type of carrier injection or junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. It should also be understood that the term LED does not limit the physical and/or electrical package type of an LED.

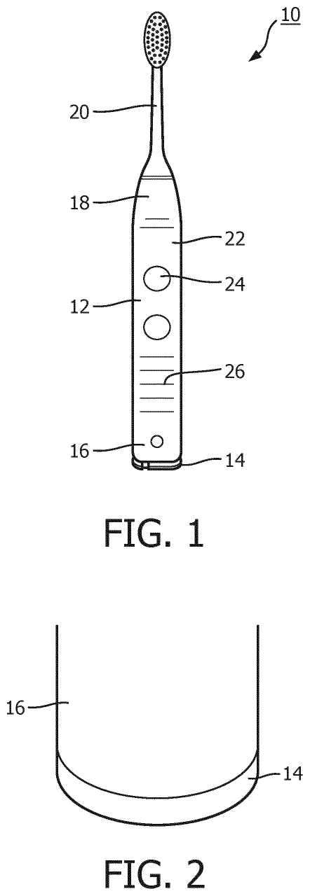

FIGS. 1-2 show an electric toothbrush 10 wherein an indicator light assembly can be used to provide an indicator light 14 at a proximal end 16 of toothbrush 10. Toothbrush 10 has a brush head 20 at its distal end 18 and a handle 12 configured to be held in a hand of a user. Housing 22 holds an internal assembly of operational components such as a drive assembly and circuit, a control unit, and a power source (e.g., battery or power cord) for producing a brush head motion suitable for effective cleaning of teeth. These operational components are not shown because they are conventional in the art of power toothbrushes. The operation of toothbrush 10 may be controlled by an on/off switch 24. In addition to holding the operational components, housing 22 also encloses components for facilitating the light ring effect as discussed below.

Toothbrush 10 further has a display area 26 located on handle 12. Display area 26 can include one or more input buttons and can also be responsive to a processor to communicate brushing information and/or indications to the user. The configuration and arrangement shown in FIGS. 1-2 is by way of example only and does not limit the scope of the embodiments disclosed below.

Housing 22 of toothbrush 10 is shaped as an elongated cylindrical member that tapers towards a top portion or distal end 18 where it is coupled to brush head 20. Housing 22 can be made of any suitable material or combination of materials.

Many types of sensors can be used in the disclosed devices to monitor a parameter and/or provide feedback to the user via an indicator light assembly. The sensors can monitor one or more parameters of the toothbrush during a working session. In some embodiments, pressure applied by a user to brush head 20 while brushing can be transmitted to a pressure sensor and one or more light sources may be activated upon the pressure sensor being subjected to a pressure that exceeds a predetermined threshold. A controller can be configured to selectively activate the light sources upon input provided by the sensor. For example, once the pressure sensor detects excessive pressure being applied by the user during a cleaning session, toothbrush 10 can provide visual feedback to a user about the amount of pressure being applied in the form of illuminating indicator light 14 at the end of handle 12. When the toothbrush is off, indicator light 14 may not be illuminated and can be hidden.

In some embodiments, a force sensor can be used to detect bristle pressure, load, or force applied against the teeth. Such force sensors can take various forms, including for example, Hall Effect sensors or other known mechanical or magnetic sensors. In other embodiments, a plaque detection sensor can be used to detect the presence of plaque on the teeth. For example, a pressure sensor can be configured to measure feedback from air applied to a dental surface to characterize the dental surface. In other embodiments, a gum detection sensor can be used to detect whether the bristle set is brushing gums rather than teeth. In further embodiments, a MEMS (micro-electro-mechanical system) gyroscope and an accelerometer can be positioned in the power toothbrush to detect rotational velocity of the brush head and orientation of the brush head in the mouth during operation. In other embodiments, infrared sensors can be used to determine the position of the bristle set in the mouth of the user.

In other embodiments, feedback can be provided for different parameters, such as the amount of force or a range of force that is applied, operating status of the toothbrush, speed of the motor of the toothbrush, or other related data. The alerts can be provided in real-time or periodically. In some embodiments, a signal may be provided during a brushing session for example when the user has brushed their teeth for a predetermined amount of time. In further embodiments, a signal may be provided to the user regarding the time the user has brushed over a number of brushing routines. The signal that is provided may be a constant signal, for example to indicate the end of a brushing routine, or an intermittent signal, such as alerting the user of brushing routine intervals. In some embodiments, wireless systems may be employed to transceive sensor data or other information. In further embodiments, a ring-shaped body may be placed at a location different from the proximal end, for example at in any section of the device where the structure and functionalities of the light guide member are desired. In some embodiments, an indicator light assembly can illuminate a light ring at a top portion of the handle or other portion of the handle where its position does not interfere with the handling of the toothbrush.

It will be appreciated that the embodiments described herein may be suitable for other types of oral care devices which do not necessarily comprise a pressure sensor or other types of sensor and/or notification functionalities. For example, embodiments described herein may be suitable for providing an indicator light wherein the indicator light is primarily used for charge indication, “scrubbing” motion feedback, illumination of icons or for providing lighting.

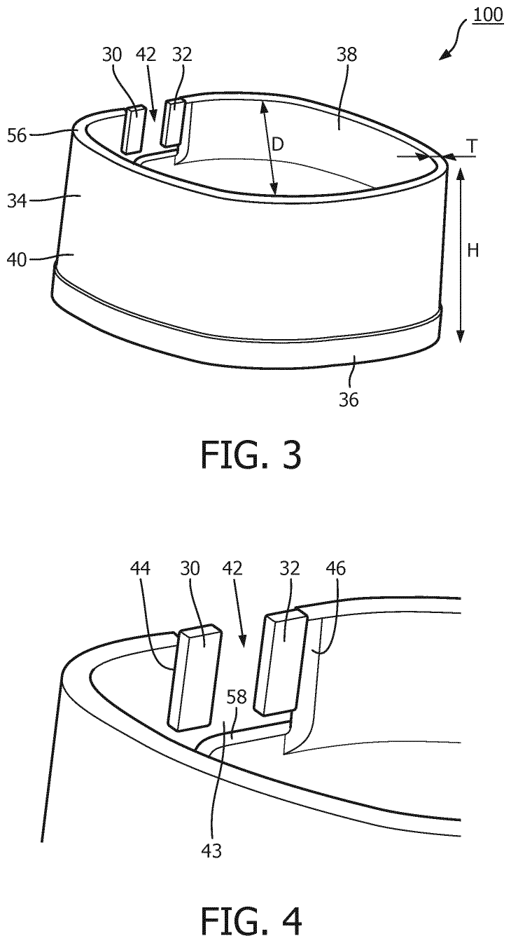

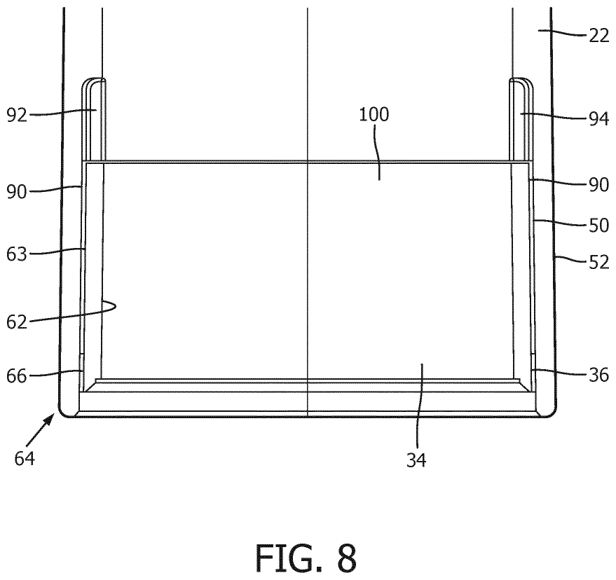

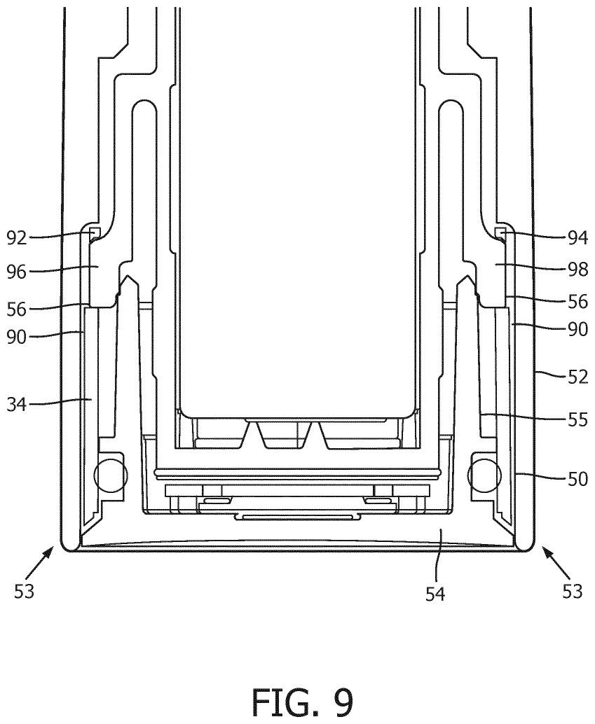

FIGS. 3-9 illustrate an embodiment of an indicator light assembly 28 as can be implemented in toothbrush 10 to create a visible light signal. Indicator light assembly 28 includes housing 22, a light guide member 100, and light sources 30, 32. Light guide member 100 includes a ring-shaped body 34 and a light coupling portion 42.

Ring-shaped body 34 has a top portion 38, formed by the upper half of the ring-shaped structure, and a bottom portion 40, formed by the lower half of the ring-shaped structure. Top portion 38 includes light coupling portion 42 to optically couple light emitted by light sources 30 and 32, in this case LEDS, to light receiving surfaces 44 and 46, respectively. Bottom portion 40 forms a closed loop and includes a light emitting surface 48 at a bottom edge 66 of ring-shaped body 34. Ring-shaped body 34 is structured such that light entering via light receiving surfaces 44 and 46 can only escape via light emitting surface 48 and thereby illuminates a portion 53 of an outer surface 52 of housing 22.

Ring-shaped body 34 is formed to generally complement the shape of housing 22. In other embodiments, a ring-shaped body can be variously configured as, for example, a loop, hoop, disc, band, halo, sphere, or any other suitable shape capable of guiding light from a light source to an outer surface of the housing. In some embodiments, the ring-shaped body can be a rectangular prism with rounded corners, a regular polygonal prism, a cylinder, an elliptical annular shape, or other tubular structure through which light can be transmitted via successive internal reflections.

Ring-shaped body 34 has a height H, a circular equivalent diameter D, and a wall thickness T along its circumference. In the example embodiment, ring-shaped body 34 has a height of 12.6 mm, a constant wall thickness of 0.94 mm, and an outer diameter of 25.08 mm. In other embodiments, the dimensions and shape of the ring-shaped body may be adjusted according to dimensions and requirements of the housing of the power device. The dimensions of the indicator light assembly can be adjusted depending on the type of user. For example, differently sized toothbrushes can be developed for adults and children or depending on the type of application.

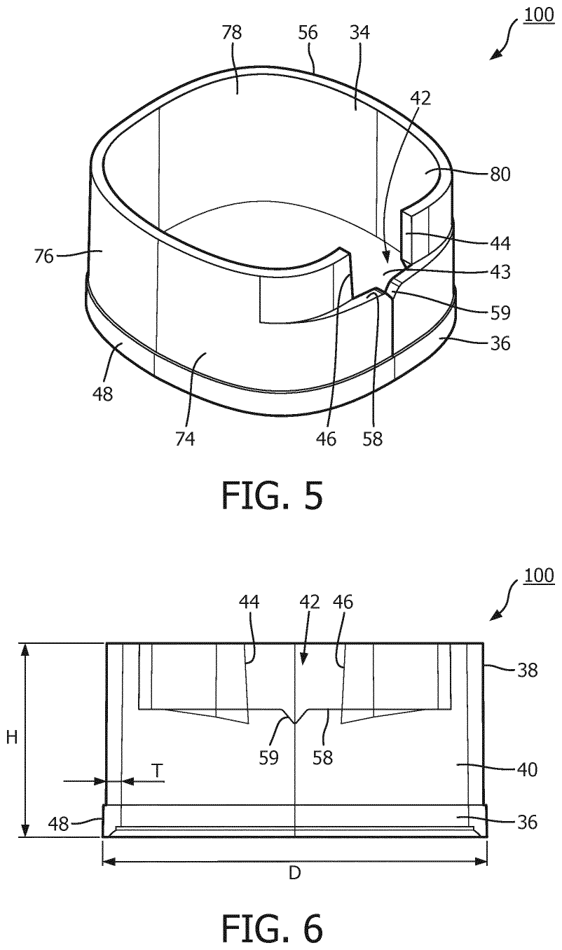

In some embodiments, ring-shaped body 34 can be made of a hard material that may need to be curved. As shown in FIG. 5, ring-shaped body 34 can be made of multiple light guide parts 74, 76, 78, 80 that are optically coupled together. In other embodiments, the ring-shaped body can be formed of a single flexible plate or as an assembly of flexible parts, for example by splicing multiple pieces by using known manufacturing methods. In some embodiments, the ring-shaped body may be attached to the housing of the handle after assembly of the internal components. In further embodiments, the ring-shaped body and the housing can be integrally formed.

Ring-shaped body 34 may be made from polycarbonate, polymethylmethacrylate (PMMA), cyclic-olefin polymers, cyclic-olefin copolymers, polyetherimide, styrene and polyesters like OKP-4, silicone materials, and similar compositions with suitable light guiding properties.

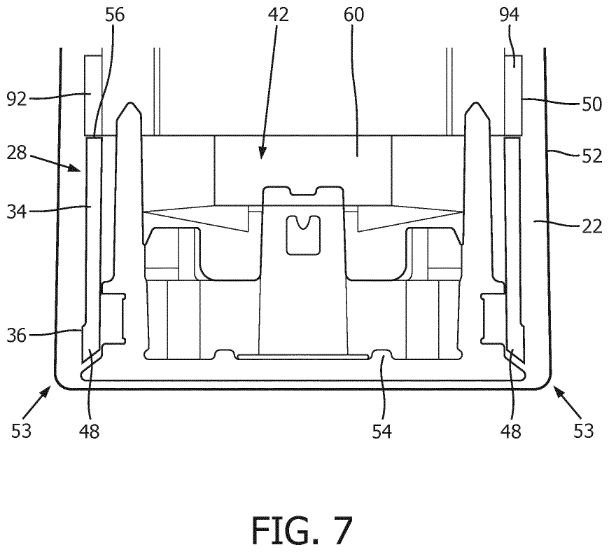

FIGS. 7-9 illustrate how light guide member 100 is disposed in housing 22. Housing 22 has an inner surface 50 and an outer surface 52. Inner surface 50 defines a cavity extending along a longitudinal axis of toothbrush 10. Light guide member 100 is disposed along inner surface 50 of housing 22 at proximal end 16 of handle 12 with its longitudinal axis being substantially parallel to the longitudinal axis of toothbrush 10.

To secure the various internal components of the toothbrush within housing 22, toothbrush 10 is provided with an end cap 54 connected to a bottom end of housing 22. In some embodiments, the end cap may be used to provide a connection to a fluid tube and/or electrical connection or charger.

Inner surface 50 of housing 22 is configured to engage an outer surface 63 of ring-shaped body in a complementary fit that allows a sliding movement of ring-shaped body 34 in the longitudinal direction of housing 22 upon assembly of toothbrush 10. Ring-shaped body 34 follows the contours of inner surface 50 of housing 22 thereby avoiding or minimalizing interference with the existing internal assembly of toothbrush 10.

In some embodiments, ring-shaped body 34 may be secured to housing 22 with a suitable adhesive, for example by applying a layer of glue between ring-shaped body 34 and housing 22. In other embodiments, a light guide member can be detachably coupled to the housing and include, for example, replaceable or interchangeable components.

Additionally, parts of the internal assembly and/or housing 22 of toothbrush 10 may be provided with structural retaining means that hold ring-shaped body 34 in place. As can be seen in FIGS. 7-9, ring-shaped body 34 fits in a narrow space between end cap 54 and housing 22. In particular, ring-shaped body 34 is disposed in a recess 90 in inner surface 50 of housing 22 and is secured between an outer surface 55 of end cap 54 and inner surface 50 of housing 22. Inner surface 50 of housing 22 includes pockets 92, 94 that are adapted to interact with locking tabs 96, 98 provided on a component of the internal assembly to keep the internal components in place. After assembly, top edge 56 of ring-shaped body 34 abuts against locking tab 96 of the internal assembly component to prevent movement of ring-shaped body 34 in the longitudinal direction of housing 22.

In other embodiments, the ring-shaped body can be adapted to fit into any suitable recess, cavity or chamber of the housing designed to secure the ring-shaped body. As such, additional sliding components or collapsing features are not needed to install the indicator light assembly, the total number of parts may be reduced and so are the tooling costs for manufacturing the toothbrush. In further embodiments, a light guide member can be permanently attached to or integrated with the housing of the toothbrush.

Returning to FIGS. 3-6, light coupling portion 42 may be formed by a cutout portion 43 located in top portion 38 of ring-shaped body 34, and sized and shaped to accommodate at least one light source. Cutout portion 43 is a rectangular shaped opening in top portion 38 made at a top edge 56 of ring-shaped body 34 which serves as a receptacle for two LEDs 30 and 32. Light receiving surfaces 44 and 46 form opposite sides of cutout portion 43. A bottom portion of cutout portion 43 is formed by an edge 58 of ring-shaped body 34. Edge 58 of ring-shaped body 34 may optionally have a V-shaped recess 59 to allow for rotational alignment of ring-shaped body 34 with inner surface 50 of housing 22 upon assembly of the toothbrush.

Light sources 30 and 32 can be mounted on a printed circuit board and coupled to a power source. The power source may be any suitable element which can provide power to the toothbrush such as a battery or other power source. To minimize light coupling losses, light sources 30 and 32 are selected based on the dimensions of light coupling portion 42 and light receiving surfaces 44 and 46. For example, light sources 30 and 32 can include two side firing red, green, blue (RGB) LEDs mounted on a printed circuit board of the internal assembly. The LEDs can be centered within the cutout portion, for example with a manufacturing tolerance of 0.6 mm spacing from the light receiving surfaces of light guide member 100. RGB LEDs can be used to output any color, a single color, or plurality of colors. The LEDs can also emit more than one level of brightness. Depending on the application of the indicator light assembly, the desired light distribution, type, and number of light sources can be adjusted. For embodiments described above, the wavelength of the light may be in the visible light range, however other embodiments may use light of a different wavelength.

In some embodiments, to capture the majority of light emitted by light sources 32 and 34, incoupling can be improved by providing light receiving surfaces 44 and 46 with additional features, for example with a tapered surface, an angled surface, multiple angled surfaces, or curved surfaces (convex or concave curvature). In other embodiments, the light source can be positioned relative to the incoupling surfaces of the ring-shaped body in any manner that allows the transmission of light from the light source through the ring-shaped body. For example, the light guide geometry can be modified such that the incoupling surface is rotated to accept light from other orientations such as an upward emitting light source.

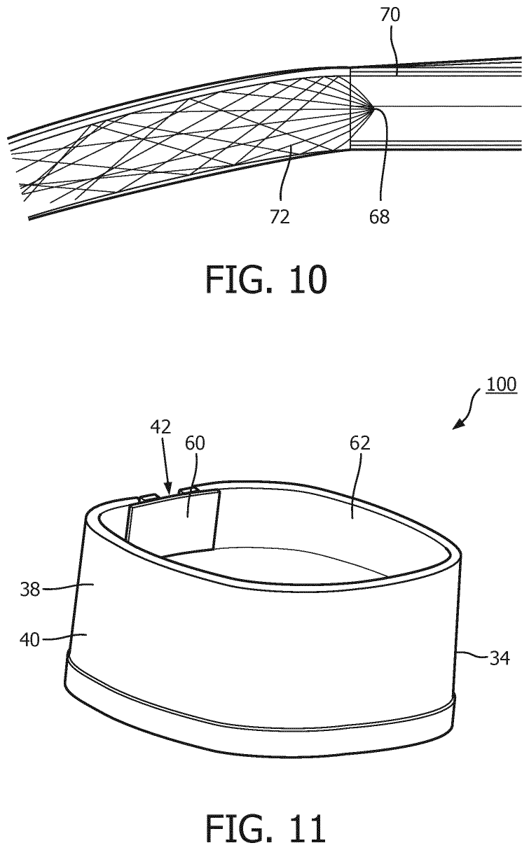

FIG. 10 illustrates the general principle of internal reflection and shows, with a simplified cross-section, how light can be propagated through a light guide member. When light is emitted by a single light source, for example LED 68, light enters light guide element 70 and propagates via internal reflection and refraction of light beams 72. The internal reflections are reflections where the light originates in a material of higher refractive index (such as polycarbonate) and reflects off of a material with lower refractive index (such as air or vacuum or water). The angle of the light entering the light guide causes there to be internal reflection off the top surface of the light guide, so nothing is needed to block the light. Although small amounts of light may be redirected upward such that they hit a top surface of the light guide with an angle close enough to normal to exit, the amount of light exiting that way is so small as to be negligible for somewhere else to be visible.

In the embodiment described above, the redirection of the light due to the surface contours of light guide member 100 allows light emitting surface 48 to illuminate portion 53 of outer surface 52 of housing 22. Because of the light guide member's ring shape, light generated by light sources 30, 32 can be emitted at bottom portion 40 of light guide member 100, and light is emitted at circumference 64 of light guide member 100 out of housing 22 thereby providing an all-around 360° light effect. As such, an indicator light is created providing light uniformly around a 360-degree circumference 64 of housing 22 at or near proximal end 16 of toothbrush 10. A user can see the indicator signal during use of the toothbrush whereby the distal end of the toothbrush is in the mouth of the user and the user's hand is holding the handle of the toothbrush. For example, the bottom 3 mm of the outer periphery of handle 12, which is typically exposed during use can be illuminated. In other embodiments, the illuminated portion can be less than the 360-degree circumference of a housing. In further embodiments, the illuminated portion of the housing can have any shape as required to provide the desired indicator function.

Optionally, a diffusing element 36 can be applied to light emitting surface 48 to enhance light distribution. Diffusing element 36 may be positioned relative to light emitting surface 48 of ring-shaped body 34 in any manner that allows the transmission of light through the diffusing element. For example, diffusing element 36 may be a translucent layer of white paint on the bottom outer diameter of ring-shaped body 34 of which the bottom 3 mm of handle 12 has a blocking layer of primer of the paint removed to allow light to pass through to the outside of housing 22.

In other embodiments, material selected for diffusing element 36 can be a clear material, transparent material, translucent material, or combinations thereof, which transmits light to the outside of the housing. Some examples of suitable materials for a diffusing element include glass, polymethyl methacrylate, polycarbonate, copolyesters, polypropylene, polyethyleneteraphthalate, silicone, combinations thereof, for example polyester and polycarbonate, or the like.

Optionally, to improve incoupling, a reflector can be used to reduce sensitivity of the light source placement relative to the light receiving surfaces. As shown in FIG. 11, a reflector 60 can be applied to an inner surface 62 of ring-shaped body 34 to cover a gap created by cutout portion 43 in top portion 38 of ring-shaped body 34 and can be configured to reflect light onto light receiving surfaces 44, 46.

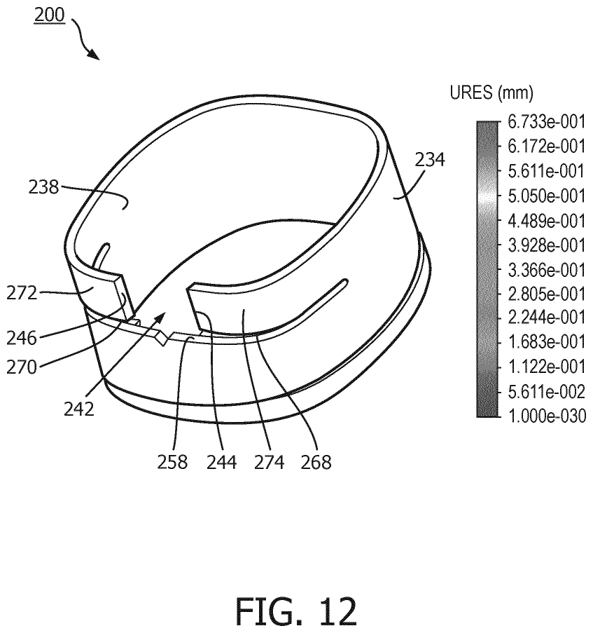

As further discussed below with reference to FIGS. 12-14, in some embodiments, a light guide member can be provided with a flexible light coupling portion to increase incoupling efficiency and to accommodate variations in printed circuit board placement while minimizing the distance between the light sources and light receiving surfaces of the light guide member.

FIG. 12 shows an embodiment wherein a light guide member 200 includes a ring-shaped body 234 made of a rigid plastic that is provided with some degree of flexibility in a top portion 238. The figure also illustrates a stress response in the material of ring-shaped body 234 to determine suitability of the material and structure without damaging the structure and functionality. To provide sufficient flexibility to ring-shaped body 234, top portion 238 is provided with two horizontal slots 268, 270 extending from a bottom edge 258 of cutout portion 242. Slots 268, 270 can be formed by horizontal slits in ring-shaped body 234 extending from an edge 258 on both sides of cutout portion 242 and thereby create compliant arms 272, 274 in top portion 238 of ring-shaped body 234. Light receiving portions 244, 242 may be located at vertical end portions of flexible arms 272, 274. In other embodiments, a compliant arm may be provided on only one side of the cutout portion.

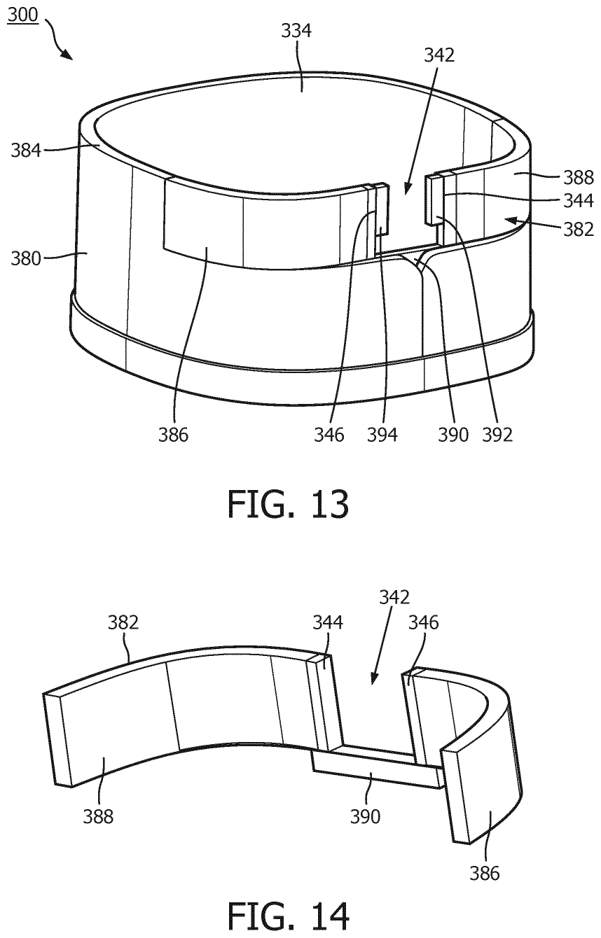

FIGS. 13 and 14 show another embodiment wherein a light guide member 300 is provided with a flexible light coupling portion. Ring-shaped body 334 includes a main body 380 and a compliant part 382. Compliant part 382 includes a light coupling portion 342 consisting of two compliant arms 386, 388 and a connector part 390 to accommodate light sources 392 and 394. Compliant part 382 can span, for example, about ⅓ of a perimeter 384 of a top portion of ring-shaped body 334. Compliant part 382 can be made of optical compliant silicone, for example, or other suitable light guiding material.

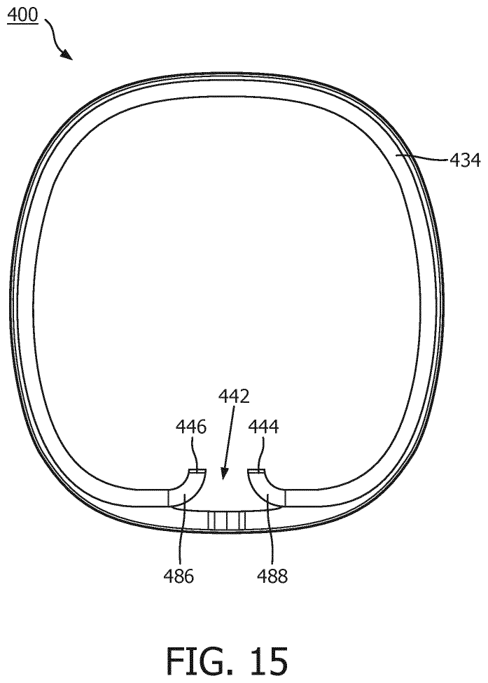

FIG. 15 shows another embodiment wherein a light guide member 400 includes a ring-shaped body 434 provided with a light coupling portion 442 formed by two extension arms 486, 488 that curve towards the center of ring-shaped body 434 to allow the coupling of light sources at the end of extension arms 486, 448. The configuration is similar to the configuration of FIGS. 13-14, however, it is to be understood that extension arms 486, 488 are formed by a portion of top edge 456 of ring-shaped body 434 curving inward and away from the housing to allow coupling of light receiving surfaces 446, 448 to light sources on a printed circuit board. In other embodiments, one or more extension arms of the light coupling portion can have many different configurations depending on the location of the light sources. For example, an extension arm can curve outward of the ring-shaped body to allow a light receiving surface to be coupled with a light source.

The embodiments and implementations disclosed herein provide a light indicator with fewer LEDs, allow for a simplified housing tool, and eliminate vacuum metal deposition on the light ring. Consequently, manufacturing processes for such devices can be streamlined and the associated costs can be substantially reduced.

Although it is described above that the power device may be an electric toothbrush, it will be understood that in alternative embodiments the oral care device may be a manual toothbrush. In these alternative embodiments, the manual toothbrush may have electrical components, but the brush head may not be mechanically actuated by an electrical component.

The inventive subject matter further contemplates a method for illuminating an outer surface portion of a housing of a power device. According to the method, a housing of a power device is provided with a light source configured to emit light in response to a parameter that is being monitored by the power device during a working session of the power device. The light guide member includes a ring-shaped body adapted to be disposed within the housing and has an outer surface that is contoured to complement an inner surface of the housing, and includes a light receiving surface and a light emitting surface. Light is caused to be emitted from the light source and the emitted light is transmitted via the light guide member to exit the housing thereby illuminating the outer surface of the housing at a proximal end of the of the power device and provides visual feedback to the user about the parameter monitored during a working session of the power device.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Applicant(s) reserves the right to submit claims directed to combinations and sub-combinations of the disclosed inventions that are believed to be novel and non-obvious. Inventions embodied in other combinations and sub-combinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. An oral care device comprising:
a housing; and
a light guide member comprising a ring-shaped body adapted to be disposed within the housing and having an outer surface contoured to complement an inner surface of the housing, a light receiving surface, a light emitting surface, and a light coupling portion adapted to accommodate a light source and configured to direct light emitted by the light source to the light receiving surface;
wherein light received by the light receiving surface propagates through the ring-shaped body via internal reflection to the light emitting surface where the light is directed out of the light guide member and uniformly illuminates a portion of an outer surface of the housing of the device.

2. The oral care device of claim 1, wherein the light coupling portion includes a cutout portion adapted to couple the light receiving surface to the light source.

3. The oral care device of claim 2, wherein the light guide member further comprises a reflector configured to bridge the cut-out portion between the light source and the light receiving surface.

4. The oral care device of claim 1, wherein the light receiving surface is located on a compliant arm of the ring-shaped body.

5. The oral care device of claim 1, wherein the light receiving surface is located on a compliant part of the ring-shaped body.

6. The oral care device of claim 1, wherein the light coupling portion includes an extension arm that curves inward towards a center of the ring-shaped body to facilitate coupling of the light sources to the light receiving surface.

7. The oral care device of claim 1, wherein the illuminated portion of the outer surface is of the housing includes an outer circumference of the housing.

8. The oral care device of claim 1, wherein the light emitting surface provides uniform illumination at a proximal end of the device.

9. The oral care device of claim 1, wherein the light guide member further comprises a diffusing element coupled to the light emitting surface and adapted for diffusing light at the outer surface of the housing.

10. An indicator light assembly for a power device, comprising:
a housing configured to be held in a hand of a user;
a light source;
a light guide member including
a ring-shaped body adapted to be disposed within the housing and having an outer surface that is contoured to complement an inner surface of the housing, the ring-shaped body including a light receiving surface, a light emitting surface, and a light coupling portion adapted to house the light source and adapted to optically couple the light source to the light receiving surface, and
wherein light received by the light receiving surface propagates through the ring-shaped body via internal reflection to the light emitting surface where the light is directed out of the light guide member and uniformly illuminates a portion of an outer surface of the housing; and
wherein the light source and the light guide member are configured to provide visual feedback to the user about a parameter being monitored during a working session of the power device.

11. The indicator light assembly of claim 10, wherein the light coupling portion includes a cutout portion adapted to couple the light receiving surface to the light source.

12. The indicator light assembly of claim 10, wherein the light receiving surface is located on a compliant arm of the ring-shaped body.

13. The indicator light assembly of claim 10, wherein the light receiving surface is located on a compliant part of the ring-shaped body.

14. The indicator light assembly of claim 10, wherein the light coupling portion includes an extension arm that curves inward towards a center of the ring-shaped body to facilitate coupling of the light sources to the light receiving surface.

15. A method for illuminating an outer surface portion of a housing of oral care device, comprising the steps of:
providing the housing of the device with
a light source configured to emit light in response to a parameter that is being monitored by the device during a working session of the device, and
a light guide member, including a ring-shaped body adapted to be disposed within the housing and having an outer surface that is contoured to complement an inner surface of the housing, a light receiving surface, a light emitting surface, and a light coupling portion adapted to accommodate the light source and configured to direct light emitted by the light source to the light receiving surface;
causing light to be emitted from the light source onto the light receiving surface; and
transmitting the emitted light via the ring-shaped body by internal reflection to the light emitting surface to exit the housing thereby uniformly illuminating a portion of an outer surface of the housing and providing visual feedback to the user about the parameter monitored during a working session of the device.
